(19) United States
(12) Patent Application Publication
(10) Pub. No.: US 2025/0305187 A1
(43) Pub. Date: Oct. 2, 2025

(54) LIGHT-COLORED FULL-SHADING BLIND FABRIC AND PREPARATION METHOD THEREFOR

(71) Applicant: GUANGZHOU HANDE NEW MATERIALS CO., LTD, Guangzhou (CN)

(72) Inventors: Zhenghui XU, Guangzhou (CN); Ding ZHENG, Guangzhou (CN); Hao QIAN, Guangzhou (CN); Jiyun LI, Guangzhou (CN); Yongfa CHEN, Guangzhou (CN); Jiangwei WANG, Guangzhou (CN); Qianyun LIANG, Guangzhou (CN); Huian HUANG, Guangzhou (CN); Yuming DENG, Guangzhou (CN); Xuguang PENG, Guangzhou (CN); Qina LIN, Guangzhou (CN)

(73) Assignee: GUANGZHOU HANDE NEW MATERIALS CO., LTD, Guangzhou (CN)

(21) Appl. No.: 19/238,229

(22) Filed: Jun. 13, 2025

Related U.S. Application Data
(63) Continuation of application No. PCT/CN2023/142351, filed on Dec. 27, 2023.

(30) Foreign Application Priority Data
Jan. 5, 2023 (CN) 2023100146661

(51) Int. Cl. D03D 15/283; D03D 15/37

(52) U.S. Cl. CPC D03D 15/283; D03D 15/37; D10B 2503/03

(57) ABSTRACT

The present invention discloses a light-colored full-shading blind fabric, including shading warp yarns and shading weft yarns which form a plain weave with the shading warp yarns, where they are both made of shading core threads, each shading core thread includes a polyester core thread with a color that is 1/12 standard depth scale greater than that of a knitted product and a matte PVC coating layer coating the polyester core thread, a contact surface between the polyester core thread and the matte PVC coating layer forms melt bonding, and the shading warp yarns and the shading weft yarns are woven to form gaps with apertures less than 1%. The light-colored full-shading blind fabric and a preparation method therefor can achieve the effect of reflecting solar radiant heat, maintaining room temperature provided by light-colored blinds, absorbing visible light and forming full shading provided by dark-colored blinds.

### CROSS-REFERENCE TO RELATED APPLICATIONS

The application claims priority to Chinese patent application No. 2023100146661, filed on Jan. 5, 2023, the entire contents of which are incorporated herein by reference.

### TECHNICAL FIELD

The present invention relates to a light-colored full-shading blind fabric and a preparation method therefor.

### BACKGROUND

Dark-colored blind fabrics can absorb visible light and reduce glare. However, dark colors may absorb more solar radiant heat, for example, blinds applied indoors may cause a poor thermal insulation effect. On the other hand, light-colored blind fabrics are more effective in reflecting solar radiant heat when used indoors, helping to maintain indoor temperature. Nevertheless, light-colored fabrics have a higher visible light transmittance, which may easily cause a dazzling sensation when light passes through the blind. Therefore, how to solve the contradiction between glare blocking and thermal insulation of indoor blinds is the current problem to be addressed.

### SUMMARY

In view of the deficiencies in the prior art, the present invention aims to provide a light-colored full-shading blind fabric and a preparation method therefor, which can not only achieve the effect of reflecting solar radiant heat and maintaining room temperature provided by light-colored blinds, but also achieve the effect of absorbing visible light and forming full shading provided by dark-colored blinds.

A technical solution used by the present invention to resolve the technical problem is:

A light-colored full-shading blind fabric, including shading warp yarns and shading weft yarns which form a plain weave with the shading warp yarns, where the shading warp yarns and the shading weft yarns are both made of shading core threads, each shading core thread includes a polyester core thread with a color that is 1/12 standard depth scale greater than that of a knitted product, a dark-colored core thread, PVC with better light-blocking performance, and a matte PVC coating layer coating the polyester core thread, a contact surface between the polyester core thread and the matte PVC coating layer forms melt bonding, and the shading warp yarns and the shading weft yarns are woven to form gaps with apertures less than 1%.

Preferably, the matte PVC coating layer is formed by matte PVC particles in a molten state extruded onto the polyester core thread.

Preferably, the matte PVC coating layer has a color that is 1/12 standard depth scale less than that of the knitted product.

Preferably, a color difference ΔE is formed between the polyester core thread and the matte PVC coating layer, and values of ΔE are all greater than 1.0.

Preferably, the shading warp yarns and the shading weft yarns have a warp and weft density of 34±5% in a warp direction and 11±5% in a weft direction.

Preferably, the shading core thread includes 25% of polyester fibers and 75% of matte PVC particles by mass percentage.

Preferably, the shading warp yarns and the shading weft yarns are subjected to plain weaving at a ratio of 2×1.

Preferably, the shading weft yarns and the shading warp yarns are subjected to plain weaving at a ratio of 2×1.

Another technical problem to be solved by the present invention is to provide a manufacturing method for a light-colored full-shading blind fabric, including the following steps:
preparing a shading core thread;
using a prepared shading core thread as a shading core thread warp yarn and a shading core thread weft yarn to perform plain weaving;
enabling a warp and weft density of weaving to be 34±5% in a warp direction and 11±5% in a weft direction;
enabling a void coefficient of weaving to be less than 1%; and
performing plain weaving to obtain the light-colored full-shading blind fabric, and extruding out gaps formed by the shading core thread warp yarn and the shading core thread weft yarn during weaving, allowing apertures of the gaps to be less than 1%.

Preferably, a manufacturing method for the shading core thread includes:
melting polyester fiber particles, and then extruding a polyester fiber thread through a die head;
melting matte PVC particles into a paste, and coating the paste on a surface of an extruded polyester fiber thread to form a matte PVC coating layer; and
enabling an extrudate to pass through cooling water, where the cooling water has a temperature of 8-25° C.

The present invention has the following beneficial effects:

After high-temperature melting treatment, PVC color masterbatches and core threads are perfectly fused together, and the surfaces of extruded (coated) yarns are smooth, which not only ensures the concentricity of thread diameters but also increases the tension, so that the shading warp yarns and the shading weft yarns can extrude out excess gaps during weaving, allowing an aperture ratio to be close to 0%. On the other hand, a matte ingredient is adopted to eliminate the original characteristic gloss of PVC, darkening the color to achieve a full-shading effect. This ultimately results in a light-colored shading blind that combines advantages of both light-colored blinds and dark-colored blinds.

### BRIEF DESCRIPTION OF THE DRAWINGS

FIG. 1 is a schematic diagram of a front structure of a light-colored full-shading blind fabric according to the present invention; and

FIG. 2 is a schematic diagram of a side structure of a light-colored full-shading blind fabric according to the present invention.

### DETAILED DESCRIPTION OF THE EMBODIMENTS

The principles and features of the present invention are described below with reference to the accompanying drawings, and the examples given are only used to explain the present invention and are not intended to limit the scope of the present invention. In the following paragraphs, the present invention is described more specifically by way of example with reference to the accompanying drawings. The advantages and features of the present invention will be clearer based on the following description and claims. It should be noted that the accompanying drawings are all in a very simplified form and use imprecise proportions, only for the purpose of conveniently and clearly assisting in explaining the embodiments of the present invention.

Unless otherwise defined, all technical and scientific terms used herein have the same meaning as those commonly understood by a person skilled in the art of the present invention. The terms used in this specification of the present invention are merely for the purpose of describing specific embodiments, but are not intended to limit the present invention. The term “and/or” as used herein includes any and all combinations of one or more of the relevant listed items.

### EMBODIMENTS

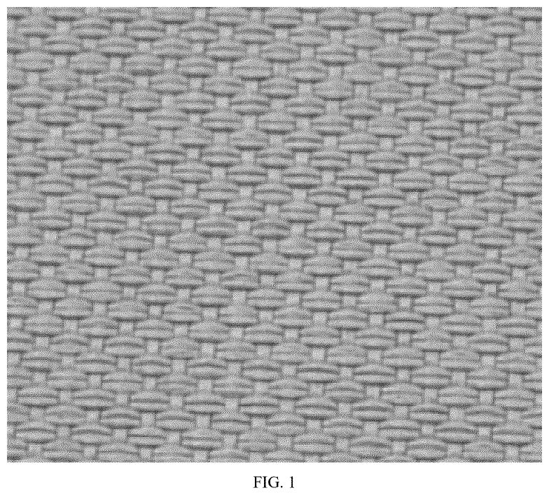

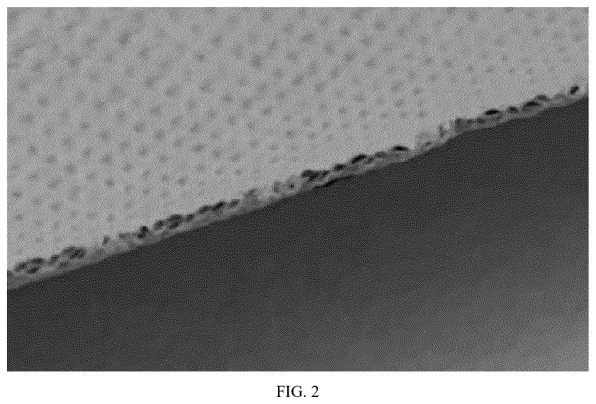

As shown in FIG. 1 to FIG. 3, a light-colored full-shading blind fabric, including shading warp yarns and shading weft yarns which form a plain weave with the shading warp yarns, where the shading warp yarns and the shading weft yarns are both made of shading core threads, each shading core thread includes a polyester core thread with a color that is 1/12 standard depth scale greater than that of a knitted product and a matte PVC coating layer coating the polyester core thread, a contact surface between the polyester core thread and the matte PVC coating layer forms melt bonding, and the shading warp yarns and the shading weft yarns are woven to form gaps with apertures less than 1%.

The matte PVC coating layer is formed by the matte PVC particles in a molten state extruded onto the polyester core thread. Due to the molten state, the matte PVC particles can be perfectly fused with the polyester core thread, making the surfaces of extruded/coated yarns smooth, which not only ensures the concentricity of thread diameters but also increases the tension. The matte PVC coating layer has a color that is 1/12 standard depth scale less than that of the knitted product, a color difference ΔE is formed between the polyester core thread and the matte PVC coating layer, and values of ΔE are all greater than 1.0. An internal sandwich is set in black, and an external coating is designed in light color.

The shading warp yarns and the shading weft yarns have a warp and weft density of 34±5% in a warp direction and 11±5% in a weft direction. The shading core thread includes 25% of polyester fibers and 75% of matte PVC particles by mass percentage. The shading warp yarns and the shading weft yarns are subjected to plain weaving at a ratio of 2×1. The shading weft yarns and the shading warp yarns are subjected to plain weaving at a ratio of 2×1. Both of the above weaving methods can be selected based on needs.

A manufacturing method for a light-colored full-shading blind fabric, including the following steps:
preparing a shading core thread;
using a prepared shading core thread as a shading core thread warp yarn and a shading core thread weft yarn to perform plain weaving;
enabling a warp and weft density of weaving to be 34±5% in a warp direction and 11±5% in a weft direction;
enabling a void coefficient of weaving to be less than 1%; and
performing plain weaving to obtain the light-colored full-shading blind fabric, and extruding out gaps formed by the shading core thread warp yarn and the shading core thread weft yarn during weaving, allowing apertures of the gaps to be less than 1%.

A manufacturing method for the shading core thread includes:
melting polyester fiber particles, and then extruding a polyester fiber thread through a die head;
melting matte PVC particles into a paste, and coating the paste on a surface of an extruded polyester fiber thread to form a matte PVC coating layer; and
enabling an extrudate to pass through cooling water, where the cooling water has a temperature of 8-25° C.

### EXPERIMENTAL EXAMPLE

A performance test of the light-colored full-shading blind fabric prepared in the present application was carried out, with specific results shown in Table 1 below.

TABLE 1

| | |
|---|---|
| Component | 25% of polyester fibers + 75% of PVC |
| Texture | Plain weave texture |
| Warp and weft density | 34 ± 5% in a warp direction, 11 ± 5% in a |
| (ASTM D3775-07) | weft direction |
| Weight per square meter | 484 g ± 5% |
| (ISO 2286-2) | |
| Thickness (ISO 2286-3) | 0.61 mm ± 5% |
| Void coefficient | ~0% |
| UV resistance coefficient | Up to 100% |
| Fire and smoke rating | FR (USA)-NFPA 701, B1 (CN)-GB8624, |
| | BS (UK)-5867 Part 2 Type B, B1 (DE)- |
| | DIN4102 |
| Health/Safety | Free of chemicals harmful to human |
| | health--Oeko-tex Standard 100 class IV, |
| | Evaluation of indoor air quality (VOC) - |
| | Greenguard, EN71 Part 3: 1994, RoHS- |
| | Lead Free, GB18586-2001 |
| Fabric width | 250-300 cm |
| Tensile strength | Warp direction ≥2280 N/5 cm, weft |
| (ISO 13934-1) | direction ≥860 N/5 cm |
| Tearing strength (ISO 4674) | Warp direction ≥129 N, weft |
| | direction ≥49 N |
| Elongation before fracture | Warp direction <27%, weft |
| (ISO 13934-1) | direction <25% |
| Color fastness to sunlight | Grade 8 |
| (ISO 105 B02) | |

The present invention has the following beneficial effects:

After high-temperature melting treatment, PVC color masterbatches and core threads are perfectly fused together, and the surfaces of extruded (coated) yarns are smooth, which not only ensures the concentricity of thread diameters but also increases the tension, so that the shading warp yarns and the shading weft yarns can extrude out excess gaps during weaving, allowing an aperture ratio to be close to 0%. On the other hand, a matte ingredient is adopted to eliminate the original characteristic gloss of PVC, darkening the color to achieve a full-shading effect. This ultimately results in a light-colored shading blind that combines advantages of both light-colored blinds and dark-colored blinds.

The above embodiments of the present invention are not intended to limit the scope of protection of the present invention, and the implementations of the present invention are not limited thereto. All other forms of modifications, substitutions, or changes made to the above structure of the present invention according to the above content of the present invention, in accordance with the general technical knowledge and conventional means of the art, and without departing from the above basic technical ideas of the present invention, shall fall within the scope of protection of the present invention.

What is claimed is:

1. A light-colored full-shading blind fabric, comprising shading warp yarns and shading weft yarns which form a plain weave with the shading warp yarns, wherein the shading warp yarns and the shading weft yarns are both made of shading core threads, each shading core thread comprises a polyester core thread with a color that is 1/12 standard depth scale greater than that of a knitted product and a matte PVC coating layer coating the polyester core thread, a contact surface between the polyester core thread and the matte PVC coating layer forms melt bonding, and the shading warp yarns and the shading weft yarns are woven to form gaps with apertures less than 1%.

2. The light-colored full-shading blind fabric according to claim 1, wherein the matte PVC coating layer is formed by matte PVC particles in a molten state extruded onto the polyester core thread.

3. The light-colored full-shading blind fabric according to claim 1, wherein the matte PVC coating layer has a color that is 1/12 standard depth scale less than that of the knitted product.

4. The light-colored full-shading blind fabric according to claim 3, wherein a color difference ΔE is formed between the polyester core thread and the matte PVC coating layer, and values of ΔE are all greater than 1.0.

5. The light-colored full-shading blind fabric according to claim 1, wherein the shading warp yarns and the shading weft yarns have a warp and weft density of 34±5% in a warp direction and 11±5% in a weft direction.

6. The light-colored full-shading blind fabric according to claim 1, wherein the shading core thread comprises 25% of polyester fibers and 75% of matte PVC particles by mass percentage.

7. The light-colored full-shading blind fabric according to claim 6, wherein the shading warp yarns and the shading weft yarns are subjected to plain weaving at a ratio of 2×1.

8. The light-colored full-shading blind fabric according to claim 6, wherein the shading weft yarns and the shading warp yarns are subjected to plain weaving at a ratio of 2×1.

9. A preparation method for a light-colored full-shading blind fabric, comprising the following steps:
preparing a shading core thread;
using a prepared shading core thread as a shading core thread warp yarn and a shading core thread weft yarn to perform plain weaving;
enabling a warp and weft density of weaving to be 34±5% in a warp direction and 11±5% in a weft direction;
enabling a void coefficient of weaving to be less than 1%; and
performing plain weaving to obtain the light-colored full-shading blind fabric, and extruding out gaps formed by the shading core thread warp yarn and the shading core thread weft yarn during weaving, allowing apertures of the gaps to be less than 1%.

10. The preparation method for a light-colored full-shading blind fabric according to claim 9, wherein a manufacturing method for the shading core thread comprises:
melting polyester fiber particles, and then extruding a polyester fiber thread through a die head;
melting matte PVC particles into a paste, and coating the paste on a surface of an extruded polyester fiber thread to form a matte PVC coating layer; and
enabling an extrudate to pass through cooling water, wherein the cooling water has a temperature of 8-25° C.
